(19) United States
(12) Patent Application Publication
(10) Pub. No.: US 2007/0212031 A1
(43) Pub. Date: Sep. 13, 2007

(54) Video monitoring system and video monitoring program

(76) Inventor: Jun Hikita, Kanagawa (JP)

Correspondence Address: WILLIAM S. FROMMER, Esq.;c/o FROMMER LAWRENCE & HAUG LLP, 745 Fifth Avenue, New York, NY, 10151, US

(21) Appl. No.: 11/713,272

(22) Filed: Mar. 2, 2007

(30) Foreign Application Priority Data
Mar. 6, 2006 (JP) P2006-059024

(51) Int. Cl. H04N 5/00

(52) U.S. Cl. 386/117

(57) ABSTRACT

Disclosed herein is a video monitoring system including: a camera connected to a network; a recorder configured to record, via the network, a video image captured by the camera; a displayer configured to display a video image captured by the camera; and a controller configured to execute control such that at least one of a current video image captured by the camera and a past video image recorded to the recorder onto be displayed on the displayer. In the monitoring system, if displaying of a past video image is specified with a current video image displayed in a window on the displayer, the controller executes control such that, while maintaining a display status of the window, the specified past video image be displayed in the window.

### CROSS REFERENCES TO RELATED APPLICATIONS

The present invention contains subject matter related to Japanese Patent Application JP 2006-059024 filed in the Japanese Patent Office on Mar. 6, 2006, the entire contents of which being incorporated herein by reference.

### BACKGROUND OF THE INVENTION

1. Field of the Invention

The present invention relates to a video monitoring system and a video monitoring program that can display video captured by a camera connected to a network and record and reproduce the video captured from that camera.

2. Description of the Related Art

Video monitoring systems are used to monitor video images captured from a plurality of cameras simultaneously displayed on one monitor display in a partitioned manner and record captured video images to reproduce later as demanded, for example. Recently, for the purpose of enhanced security, video-based monitoring activities are practiced in various places, such as company parking lots, streets, schools, and homes, in addition to banks, convenience stores, and other monitored facilities in the past (refer to Japanese Patent Laid-Open No. 2001-309368 and Japanese Patent Laid-Open No. Hei 10-336631).

At the same time, network-based video monitoring systems in which a plurality of cameras are connected to a network and video images captured by these cameras and transmitted through the network for display, storage, and reproduction are managed have been quickly spreading due to the enhanced performance and reduced cost of cameras, the increased storage size and decreased cost of recording media, and the quick development of networks.

### SUMMARY OF THE INVENTION

However, with the above-mentioned related-art video monitoring systems, reading the past video for reproduction with the video captured by cameras displayed demands the processing of searching a database (or a storage media) for desired video by specifying cameras and dates. In this processing, a search condition specification window is displayed in a pop-up manner in addition to a video window currently displayed for a search operation, the search condition specification window being used for camera specification and past date specification. Thus, separately displaying the search condition specification window causes a problem of getting in the way of the currently displayed video, thereby degrading the visibility of the monitor screen.

Therefore, the present invention addresses the above-identified and other problems associated with related-art methods and apparatuses and solves the addressed problems by providing a video monitoring system and a video monitoring program. In carrying out the invention and according to one embodiment thereof, there is provided a video monitoring system. This video monitoring system has a camera connected to a network; a recorder configured to record, via the network, a video image captured by the camera; a displayer configured to display a video image captured by the camera; and a controller configured to execute control such that at least one of a current video image captured by the camera and a past video image recorded to the recorder onto be displayed on the displayer. In this video monitoring system, if displaying of a past video image is specified with a current video image displayed in a window on the displayer, the controller executes control such that, while maintaining a display status of the window, the specified past video image be displayed in the window.

In carrying out the invention and according to another embodiment thereof, there is provided a video monitoring program. If the displaying of a past video image is specified with a current video image displayed in a window on the displayer by the program control by the controller, this video monitoring program displays the specified past video image in that window while maintaining the display status of that window.

Consequently, in searching for past video images and displaying retrieved past video images so as to display any of specified past video images into a window on the displayer in which a current video image is being displayed, the search and retrieval operations can be executed without changing window layouts.

As described and according to the embodiments of the present invention, the user can reference desired past video images with the window status in which currently captured video maintained. This novel setup makes it unnecessary to switch between screen statuses, thereby enabling to reproduce past video images while monitoring the currently displayed video.

### BRIEF DESCRIPTION OF THE DRAWINGS

FIG. 1 is a schematic diagram illustrating an exemplary configuration of a video monitoring system practiced as one embodiment of the invention;

FIG. 2 is a schematic diagram illustrating an exemplary configuration of a video monitoring program practiced as another embodiment of the invention; and

FIG. 3 is a diagram illustrating an exemplary display of video images captured from a plurality of cameras onto a monitor.

### DETAILED DESCRIPTION OF THE PREFERRED EMBODIMENTS

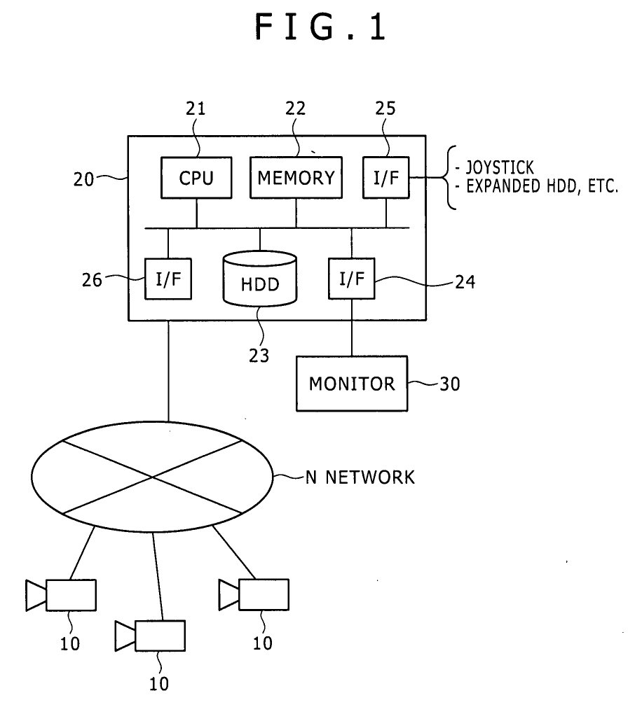

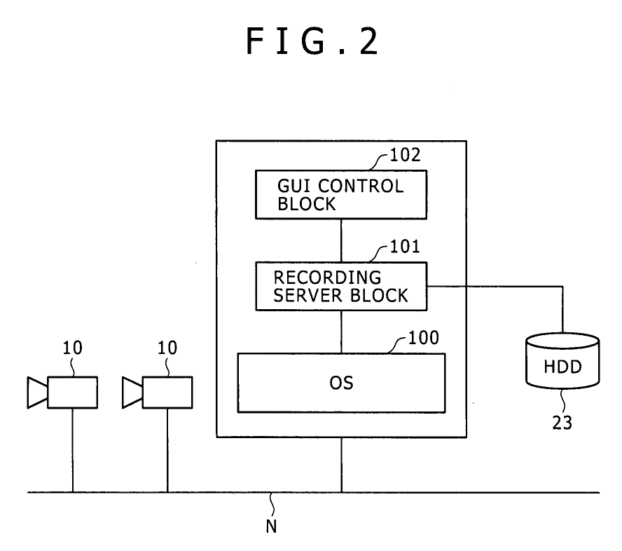

This invention will be described in further detail by way of embodiments thereof with reference to the accompanying drawings. Now, referring to FIG. 1, there is shown a schematic diagram illustrating an exemplary configuration of a video monitoring system practiced as one embodiment of the present invention. Referring to FIG. 2, there is shown a schematic diagram illustrating an exemplary configuration of a video monitoring program practiced as another embodiment of the present invention.

As shown in FIG. 1, a video monitoring system according to the present embodiment has a camera 10 (or cameras 10) connected to a network N, a monitoring apparatus 20 connected to the same network N, and a monitor (or display means) 30 connected to the monitoring apparatus 20. In this video monitoring system, an image captured by the camera 10 is transmitted to the monitoring apparatus 20 via the network N in a predetermined data format. The predetermined data format is JPEG (Joint Photographic Experts Group) or MPEG-4 (Moving Picture Experts Group phase 4), for example. The image received by the monitoring apparatus 20 is displayed on the monitor 30 connected the monitoring apparatus 20 or stored in a HDD (Hard Disk Drive) 23, a storage arranged on the monitoring apparatus 20. It is also practicable to search the HDD 23 for desired images and reproduce retrieved images.

In order to manage the video supplied from the camera 10 via the network N, the monitoring apparatus 20 has a CPU 21 that provides control means for executing a video monitoring program, a memory 22, such as a RAM (Random Access Memory) providing a work area for use by image processing, and the HDD 23 that provides storage means for sequentially storing video images supplied from the camera 10. The monitoring apparatus 20 has a monitor interface 24 for connecting the monitor 30, an external device interface 25 for connecting external devices, such as a joystick and an extended HDD, and a network interface 26 for connecting the present system to the network N.

The video monitoring program to be executed by the CPU 21 is made up of a recording server block 101 to be executed in an operating system 100 and a GUI (Graphical User Interface) control block 102 as shown in FIG. 2. The recording server block 101 records each video image supplied from the camera 10 along with a camera identification number, recording date, and data compression algorithm, for example, to HDD 23, thereby executing the processing of building a video database. The recording server block 101 also searches the HDD 23 for specified video images and reproduces the retrieved video images.

The GUI control block 102 executes window control processing for displaying video on the monitor 30 (refer to FIG. 1), display control processing for allocating video to windows and displaying various control buttons (or icons) to windows, and control processing for accepting commands from a user through input means, such as mouse, keyboard, functional buttons, and joystick.

The above-mentioned system configuration and program configuration supply the video captured by the camera 10 to the monitoring apparatus 20 via the network N to be displayed on the monitor 30. If a plurality of cameras 10 are connected to the network N, then each of video images captured by these cameras can be displayed in each of windows, which are displayed on the monitor 30 as arranged in a predetermined manner. Alternatively, only a window for one particular camera 10 can be displayed on the entire monitor 30. If the camera 10 has pan, tilt and zoom capabilities, the user can use these capabilities of the camera 10 to display a resultant image on the monitor 30.

Video images captured by the camera 10 are sequentially recorded to the HDD 23 to build a video database. When a video database is built in the HDD 23, the user can access the video database from the monitoring apparatus 20 to retrieve desired video images and, because the monitoring apparatus 20 is also connected to the network N, access the video database from an external personal computer, for example, connected to the network N to reference desired video images.

In displaying and reproducing video images as described above, if the reproduction of past video images is specified by the user with a current video image captured by the camera 10 shown on the monitor 30, the video monitoring system according to the present embodiment can execute the displaying of a past video image with that display status maintained. This is one of features of this video monitoring system.

To be more specific, if a current video image captured by one particular camera 10 is being shown in one particular window, the user can search for a past video image (by specifying a date of capture, for example) without being bothered by the video display status of that window, thereby switching the display on that window from the current video image to the retrieved past video image. This allows the user to search for past video images while referencing a displayed current video image and specify the reproduction of retrieved past images onto the window in which the current video image is being shown.

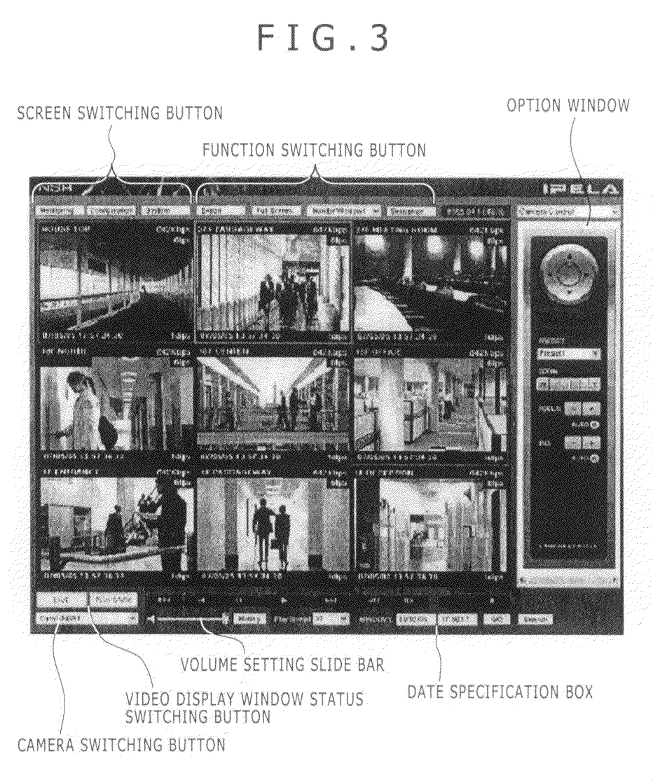

The above-mentioned display control processing is realized by the program control of the GUI control block 102, which is especially effective when displaying video images captured from a plurality of cameras onto a plurality of windows. Referring to FIG. 3, there is shown an example in which video images captured from a plurality of cameras are displayed onto the monitor. To be more specific, the video images supplied from two or more cameras are displayed in two or more windows, which are arranged in a matrix manner. In the example shown in FIG. 3, a total of nine windows (3×3) are displayed, in each of which a video image captured by a different camera is displayed. Namely, the video images supplied from a total of nine cameras can be referenced at the same time. It should be noted that the number of windows that can be displayed and the display layout can be selected by the user as demanded.

On top of the video display screen, screen switching buttons and function switching buttons are arranged. The screen switching buttons selects contents to be displayed on the entire screen and include a monitoring button for displaying a video image captured by a camera, a configuration button for setting basic information, and a system button for setting system-associated information.

The function selecting buttons include an export button for outputting video images captured by a camera to an external recording media, a full screen button for displaying a selected window on the full screen, a monitor window button for selecting a layout (3×3, 2×2, or the like) of two or more windows, and a sequence button for starting or stopping a monitor sequence for automatically switching between screens.

Arranged below the whole window are a video display window status (displaying of current video or reproducing of past video) switching button, a reproduction/recording operation button, a camera switching button, a volume setting slide bar, and a data specification box for specifying the date and time for search for past video.

In addition, to the right side of the whole window, an operation window is arranged. For the option window, “camera control,” “list of recording cameras,” “list of recorded images,” “system log,” “alarm log,” “list of alarm output situations,” “list of sensor input situations,” “list of moving body detection situations,” and “manual trigger” can be selected by the window switching button.

Selecting “camera control” switches to a window for controlling the panning, tilt, and zoom of a specified window, and the camera functions, such as focus and brightness. Selecting “list of recording cameras” displays a list of cameras that are taking video onto the option window. Selecting “list of recorded images” displays a list of recently recorded images onto the option window.

Selecting “alarm log” displays an alarm-associated log onto the option window. Selecting “system log” displays a log associated with system information and system error onto the option log. Selecting “list of alarm output situations” displays a list of current alarm output situations onto the option window. Selecting “list of sensor input situations” displays a list of current sensor output situations onto the option window.

Selecting “list of moving body detection situations” displays current moving body detection information onto the option windows. Selecting “manual trigger” displays a list of manually triggered actions onto the option window.

The user can specify, as desired, which camera is to be selected to display video onto a particular window. Namely, when the user selects a desired camera by pressing the camera selecting button with a particular window specified, the video of the specified camera is displayed on the specified window.

If “camera control” is displayed on the option window with the window displayed with video specified and an arrow button, for example, is selected, the user can perform panning or tilting of the camera transmitting video to that window or specify zoom-in or zoom-out of the video by selecting the zoom button.

In order to reference video captured in the past, the user selects the window in which the current video transmitted from the camera by which the desired past video was captured is displayed and enters the referenced past date on which into the date specification box. In the present embodiment, the date specification box is arranged in the lower right corner of the whole window, by which the user can specify one date and time common to a plurality of windows.

It is also practicable to simultaneously specify two or more windows that correspond to the camera by which the past video to be referenced was captured. If two or more windows are specified, there is one box in which the date is specified, so that one date and time common to two or more windows can be specified in this box.

In the video monitoring system according to the present embodiment, if a desired date is entered in the above-mentioned date specification box to specify the displaying of past video with the current video displayed in a window, the user can display the past video in the same window with the current display status of this window maintained.

To be more specific, in order to display past video in related-art video monitoring systems, the user has to pop up a window separate from the current window and enter the date of past video to be displayed in that pop-up window, in which the specified video is displayed. Consequently, the specified past video is displayed over the currently displayed window in an overlapped manner, thereby causing a problem of totally or partially screening out the currently displaying window with a date specification or past video image.

On the contrary, in the present embodiment, past dates can be specified with the window status (or window layout) displaying current video maintained and past video can be displayed in the current video displaying window in place of the current video, thereby preventing the displaying of overlapped windows.

To be more specific, the user specifies a window in which a video image captured by a camera by which past video is to be referenced with the current video images captured by a total of nine cameras in 3×3 windows displayed, for example, and then enters a date to be referenced into the date specification box arranged in the lower right corner of the whole window. Consequently, while date specification is being executed, the current video images are displayed in all windows including the above-specified window, so that the date specification window will not be hidden by another window.

When “GO” button by the side of the date specification box is pressed, the video image in the above-specified window is displayed in place of the past video image captured by each camera. Namely, a video image captured in the past by a predetermined camera is displayed in the same window in which the current video image captured by that camera is displayed. This display control allows the user to reference the current video image while a past date is being specified. When the “GO” button is pressed with a date specified, the video image of the specified date captured by the camera of the specified window can be displayed in that window.

As described above, the specification of date and the displaying of past video are executed by maintaining the display status of the same window, so that the user can reference past video in the specified window without being hidden by another window and, at the same time, reference the current video in another window.

In order to return to the displaying of current video after referencing past video, the user presses “LIVE” button of the buttons for switching between video display window statuses (current video display “LIVE”/past video reproduction “PLAYBACK”). Consequently, the past video is reproduced and the displaying of the window is switched to the displaying of the current video.

The screen display control feature as described above allows, while maintaining the display layout of a particular window, the user to display the specified past video in that window, thereby searching for past video images and displaying retrieved past video images without changing window layouts. Consequently, in referencing desired past video images, the user can reference the past video images of a desired camera while continuing the monitoring of video in the current screen display layout.

While preferred embodiments of the present invention have been described using specific terms, such description is for illustrative purpose only, and it is to be understood that changes and variations may be made without departing from the spirit or scope of the following claims.

What is claimed is:

1. A video monitoring system comprising:
a camera connected to a network;
recording means configured to record, via said network, a video image captured by said camera;
display means for displaying a video image captured by said camera; and
control means for executing control such that at least one of a current video image captured by said camera and a past video image recorded to said recording means onto be displayed on said display means;
wherein, if displaying of a past video image is specified with a current video image displayed in a window on said display means, said control means executes control such that, while maintaining a display status of said window, said specified past video image be displayed in said window.

2. The video monitoring system according to claim 1, wherein, if video images captured by a plurality of said cameras are displayed in a plurality of windows on said display means on a one in one basis and displaying of a past video image is specified for a video image of at least one camera in this status,
said control means executes control such that, while display statues of a plurality of windows on said display means are maintained, a past video image captured by a camera corresponding to a window for displaying a video image of at least one camera be displayed in said window.

3. The video monitoring system according to claim 1, wherein said control means executes control such that a date specification input box be displayed on said display means for specifying a past video image while maintaining a display status of a window on said display means.

4. The video monitoring system according to claim 2, wherein, in accepting said specification of a past video image, said control means accepts one common date specification for selecting a window in which to display a video image captured by said at least one camera.

5. A video monitoring program to be executed on a video monitoring system comprising:
a camera connected to a network;
recording means for recording, via said network, a video image captured by said camera;
display means for displaying a video image captured by said camera; and
control means for executing control such that at least one of a current video image captured by said camera and a past video image recorded to said recording means onto be displayed on said display means;
wherein, if displaying of a past video image is specified with a current video image displayed in a window on said display means by program control by said control means, processing of displaying said specified past video image with a display status of said window maintained is executed.

6. The video monitoring program according to claim 5, wherein
if video images captured by a plurality of said cameras are displayed in a plurality of windows on said display means on a one in one basis and displaying of a past video image is specified for a video image of at least one camera in this status,
while display statues of a plurality of windows on said display means are maintained, processing of displaying a past video image captured by a camera corresponding to a window for displaying a video image of at least one camera into said window is executed by program control by said control means.

7. The video monitoring program according to claim 5, wherein processing of displaying a date specification input box onto said display means for specifying a past video image while maintaining a display status of a window on said display means is executed by program control by said control means.

8. The video monitoring program according to claim 6, wherein, in accepting said specification of a past video image by program control by said control means, one common date specification for selecting a window in which to display a video image captured by said at least one camera is accepted.
